(19) United States
(12) Patent Application Publication
(10) Pub. No.: US 2020/0167770 A1
(43) Pub. Date: May 28, 2020

(54) BLOCKCHAIN IMPLEMENTATION ACROSS MULTIPLE ORGANIZATIONS

(71) Applicant: Bank of America Corporation, Charlotte, NC (US)

(72) Inventors: Manu Kurian, Dallas, TX (US); Lalit Dhawan, Franklin Park, NJ (US)

(21) Appl. No.: 16/202,471

(22) Filed: Nov. 28, 2018

(51) Int. Cl. G06Q 20/38; H04L 9/06; G06Q 20/24

(52) U.S. Cl. CPC G06Q 20/389; G06Q 20/24; H04L 9/0643

(57) ABSTRACT

Methods and systems for management of blockchains across multiple organizations. A primary blockchain may comprise blocks corresponding to relationships between an entity and one or more organizations. A secondary blockchain may comprise blocks corresponding to relationships between the one or more organizations. The relationship between the entity and the one or more organizations may correspond to an action. Performance of the action may cause creation of a block in the primary blockchain. Based on the relationships between the one or more organizations as stored in blocks in the secondary blockchain, actions may be implemented, and/or blocks in blockchains corresponding to organizations may be created.

### FIELD

Aspects described herein generally relate to the management of data, and more particularly using blockchains to track information and manage relationships between organizations.

### BACKGROUND

The increasing size and complexity of data and relationships between data, particularly where such data involves multiple organizations, can introduce data management difficulties. In particular, it can be difficult for multiple organizations to manage data jointly, separately, and yet consistently. A simplified example of this problem is provided. Two organizations, such as two local news stations, may agree to work on a series of blog posts for a national news website. A first organization (e.g., a first local news station) of the two organizations may work on a first portion of the blog posts, and a second organization (e.g., a second local news station) of the two organizations may work on a second portion of the same blog posts. The owner of the national news website may want the blog posts to be completed on time, but be relatively uninvolved in the creation of the blog posts. This relatively simple process may nonetheless create at least three sets of data: portions of blog posts created by the first organization, portions of blog posts created by the second organization, and finalized blog posts provided to the national news website. While all sets of data may be important, only the latter set of data may be critical from the perspective of the national news website operator and the readers of the national news website. For example, the particular writing responsibilities of the first local news station as compared to the second local news station may be irrelevant to the owner/readers of the national news website. Nonetheless, it may be helpful to track the responsibilities of different organizations and their respective contributions, particularly if such organizations are able to delegate or reassign work to other organizations. After all, the different organizations may be paid based on the quantity/quality of their respective contributions. But, for example, if the aforementioned national news website owner is forced to manage the minutia of which local news station is tasked with writing any given sentence in a blog post, significant time and effort may be needlessly wasted.

There is thus an ongoing need for methods to better receive, track, and process data, particularly in environments involving multiple organizations with different relationships.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To better receive, track, and process data, and to overcome other limitations that will be apparent upon reading and understanding the present specification, aspects described herein are directed towards the use of a blockchain for data management across multiple organizations.

A primary blockchain may correspond to a primary set of data corresponding to an entity and a plurality of organizations. For example, the entity may be a website, and the plurality of organizations may be contributors to one or more blog posts on the website. The primary set of data may, for example, reflect a history of actions taken with respect to the entity by the plurality of organizations. For example, the primary blockchain may be created when the plurality of organizations agree to write one or more blog posts, and additional blocks may be created corresponding to every blog post created by the plurality of organizations. The plurality of organizations associated with the primary blockchain may also be associated with an intermediary blockchain. The intermediary blockchain may be associated with the primary blockchain and may correspond to relationships between each of the plurality of organizations. For example, the intermediary blockchain may indicate that a first organization is responsible for a first half of a given blog post, and that a second organization is responsible for a second half of the given blog post. The intermediary blockchain may be private or otherwise limited to the plurality of organizations, such that the entity need not have access to the intermediary blockchain. Based on a change in relationships between the plurality of organizations, a block may be created in the intermediary blockchain. Each organization of the plurality of organizations may maintain an individual blockchain, which may correspond to the intermediary blockchain and/or the primary blockchain. For example, the individual blockchain may indicate one or more individuals, of the organization, responsible for writing the portion of the blog post that the organization is responsible for. The entity may perform an action, and/or one or more of the plurality of organizations may perform an action. Based on the action, a block may be created in the primary blockchain, and/or a block may be created in the intermediary blockchain. Further based on the action, benefits of the action (e.g., payment for a blog post) may be apportioned to one or more of the plurality of organizations.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative example of centralized computer system in accordance with one or more illustrative aspects described herein.

FIG. 2 depicts an illustrative example of decentralized P2P computer system that may be used in accordance with one or more illustrative aspects described herein.

FIG. 3A depicts an illustrative example of a full node computing device that may be used in accordance with one or more illustrative aspects described herein.

FIG. 3B depicts an illustrative example of a lightweight node computing device that may be used in accordance with one or more illustrative aspects described herein

FIG. 4A depicts multiple organizations and multiple blockchains with respect to a website.

FIG. 4B depicts multiple organizations and multiple blockchains with respect to a loan.

FIG. 5 is a flow chart which may be performed by a computing device and with respect to multiple blockchains.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As a general introduction to the subject matter described in more detail below, aspects described herein are directed towards managing data across multiple organizations using a decentralized peer-to-peer system implementing, for example, a blockchain.

The disclosure provided herein is described, at least in part, in relation to a decentralized peer-to-peer (e.g., P2P) system specialized for the purpose of managing a blockchain. The decentralized P2P computer system may be comprised of computing devices that are distributed in multiple locations across a geographical area as opposed to a single location such as a business or company. The computing devices forming the decentralized P2P computer system may operate with each other to manage a blockchain, which may be a data structure used to store information related to the decentralized P2P computer system. More specifically, the blockchain may be a chronological linkage of data elements (e.g., blocks) which store data records relating to the decentralized computing system.

The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, a wallet associated with the user may indicate that the requested network-specific function has been performed in some implementations.

In more detail, the decentralized P2P computer system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P computer system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. A plurality of network function requests may be broadcasted across at least a portion of the full nodes of the decentralized network, aggregated through execution of the one or more digital cryptographic hash functions, and validated by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, digital content storage and delivery, entity authentication and authorization, digital identity, marketplace creation and operation, internet of things (e.g., IoT), prediction platforms, election voting, medical records, P2P transfers, ride sharing, gaming, trading platforms, real estate, precious metal, and work of art registration and transference, among others. A “private blockchain” may refer to a blockchain of a decentralized private system in which only authorized computing devices are permitted to act as nodes in a decentralized private network and have access to the private blockchain. The private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. The public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. Network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. The data generated in performing network-specific functions may be stored on a blockchain associated with the decentralized P2P network. Examples of network functions may include “smart contract operations” and “balance sheet transaction.” A smart contract operation, as used herein, may describe one or more operations performed by a “smart contract,” which may be one or more algorithms and/or programs associated with one or more nodes within a decentralized P2P network. A balance sheet transaction may describe one or more changes to data holdings associated with one or more nodes within a decentralized network.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network.

As will be described in further detail below, a decentralized P2P computer system implementing a blockchain data structure may provide solutions to technological problems existing in current centralized system constructs with traditional data storage arrangements. For example, data storage arrangements that use a central data authority may have a single point of failure (namely, the central storage location) which, if compromised by a malicious attacker, can lead to data tampering, unauthorized data disclosure, and exploitation and/or loss of operative control of the processes performed by the centralized system. The implementation of a blockchain data structure in a decentralized P2P computer system acts as a safeguard against unreliable and/or malicious nodes acting in the decentralized P2P network to undermine the work efforts of the other nodes, e.g., by providing byzantine fault tolerance within the network.

Computing Architectures

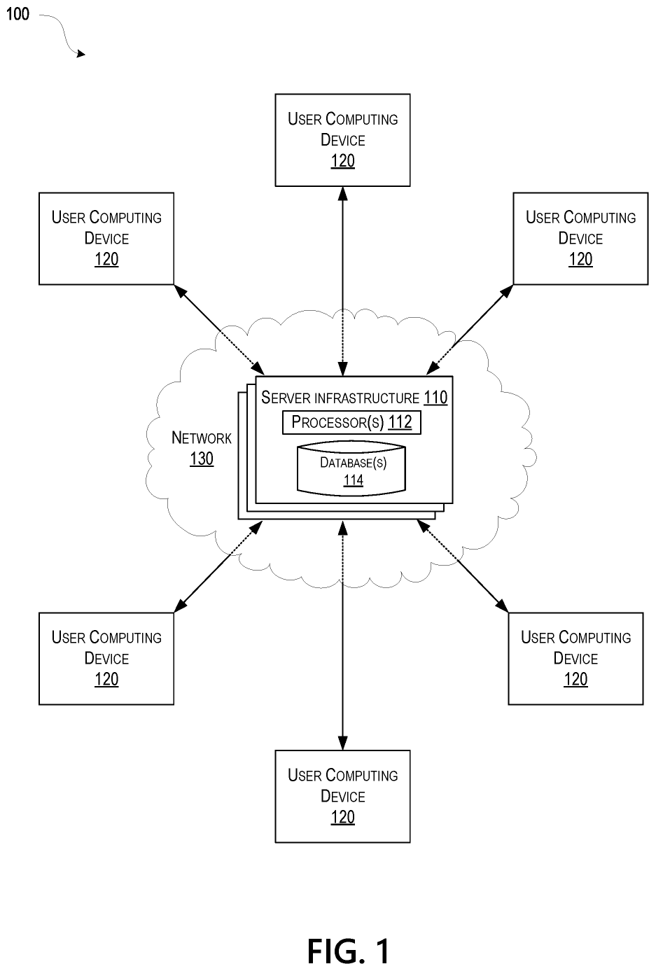

FIG. 1 depicts an illustrative example of a centralized computer system 100 in accordance with one or more illustrative aspects described herein. Centralized computer system 100 may comprise one or more computing devices including at least a server infrastructure 110 and user computing devices 120. Each of user computing devices 120 may be configured to communicate with the server infrastructure 110 through a network 130. The centralized computer system 100 may include additional computing devices and networks that are not depicted in FIG. 1, which also may be configured to interact with the server infrastructure 110 and/or the user computing devices 120.

The server infrastructure 110 may be associated with a distinct entity such as an organization, company, school, government, and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. The server infrastructure 110 may include computing hardware and software that may host various data and applications for performing tasks of the centralized entity and interacting with the user computing devices 120, as well as other computing devices. For example, each of the computing devices comprising the server infrastructure 110 may include at least one or more processors 112 and one or more databases 114, which may be stored in memory of the one or more computing devices of the server infrastructure 110. Through execution of computer-readable instructions stored in memory, the computing devices of the server infrastructure 110 may be configured to perform functions of the centralized entity and store the data generated during the performance of such functions in the one or more databases 114.

The server infrastructure 110 may include and/or be part of enterprise information technology infrastructure and may host a plurality of enterprise applications, enterprise databases, and/or other enterprise resources. Such applications may be executed on one or more computing devices included in the server infrastructure 110 using distributed computing technology and/or the like. The server infrastructure 110 may include a relatively large number of servers that may support operations of a particular enterprise or organization, such as a financial institution. The server infrastructure 110, for example, may generate a single centralized ledger for data received from the user computing devices 120, which may be stored in the databases 114.

Each of the user computing devices 120 may be configured to interact with the server infrastructure 110 through the network 130. One or more of the user computing devices 120 may be configured to receive and transmit information corresponding to system requests through particular channels and/or representations of webpages and/or applications associated with the server infrastructure 110. The system requests provided by the user computing devices 120 may initiate the performance of particular computational functions such as data and/or file transfers at the server infrastructure 110. The one or more of the user computing devices may be internal computing devices associated with the particular entity corresponding to the server infrastructure 110 and/or may be external computing devices which are not associated with the particular entity.

As stated above, the centralized computer system 100 also may include one or more networks, which may interconnect one or more of the server infrastructure 110 and one or more of the user computing devices 120. For example, the centralized computer system 100 may include the network 130. The network 130 may include one or more sub-networks (e.g., local area networks (LANs), wide area networks (WANs), or the like). Furthermore, the centralized computer system 100 may include a local network configured to each of the computing devices comprising the server infrastructure 110.

The centralized computer system 100 may include a plurality of computer systems arranged in an operative networked communication with one another through a network, which may interface with the server infrastructure 110, the user computing devices 120, and/or the network 130. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

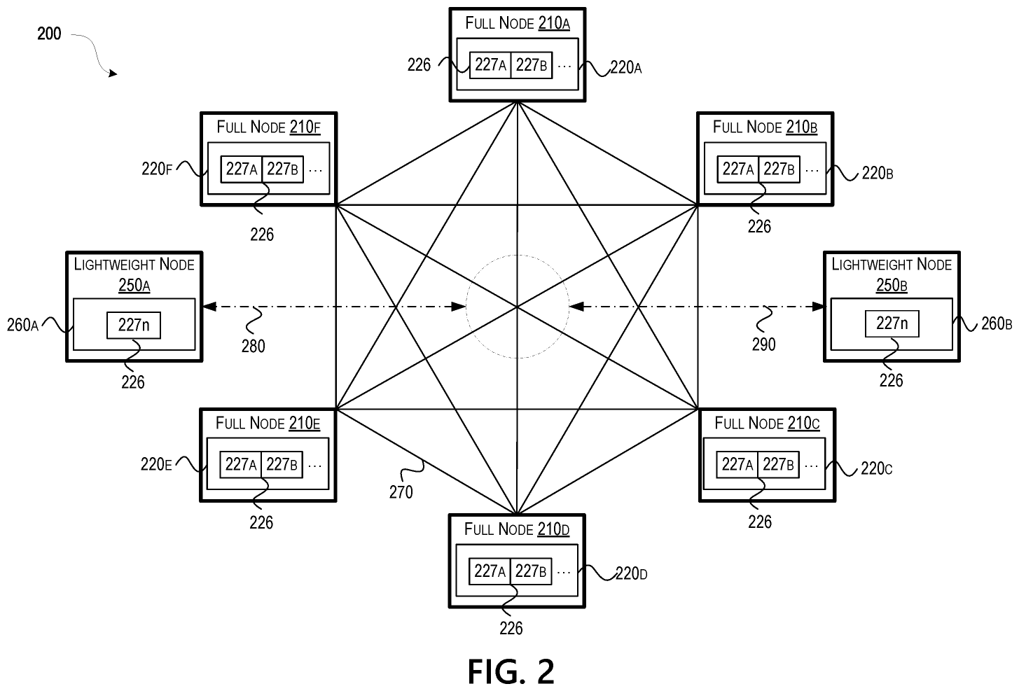

In the centralized computer system 100 described in regard to FIG. 1, the server infrastructure 110 may serve as a central authority which manages at least a portion of the computing data and actions performed in relation to the particular entity associated with the server infrastructure 110. As such, the server infrastructure 110 of the centralized computer system 100 provides a single point of failure which, if compromised by a malicious attacker, can lead to data tampering, unauthorized data disclosure, and exploitation and/or loss of operative control of the processes performed by the server infrastructure 110 in relation to the particular entity associated with the server infrastructure 110. In such a centralized construct in which a single point of failure (e.g., the server infrastructure 110) is created, significant technological problems arise regarding maintenance of operation and data control, as well as preservation of data integrity. As will be described in further detail below in regard to FIG. 2, such technological problems existing in centralized computing arrangements may be solved by a decentralized P2P computer system implementing a blockchain data structure, even wholly within the server infrastructure 110.

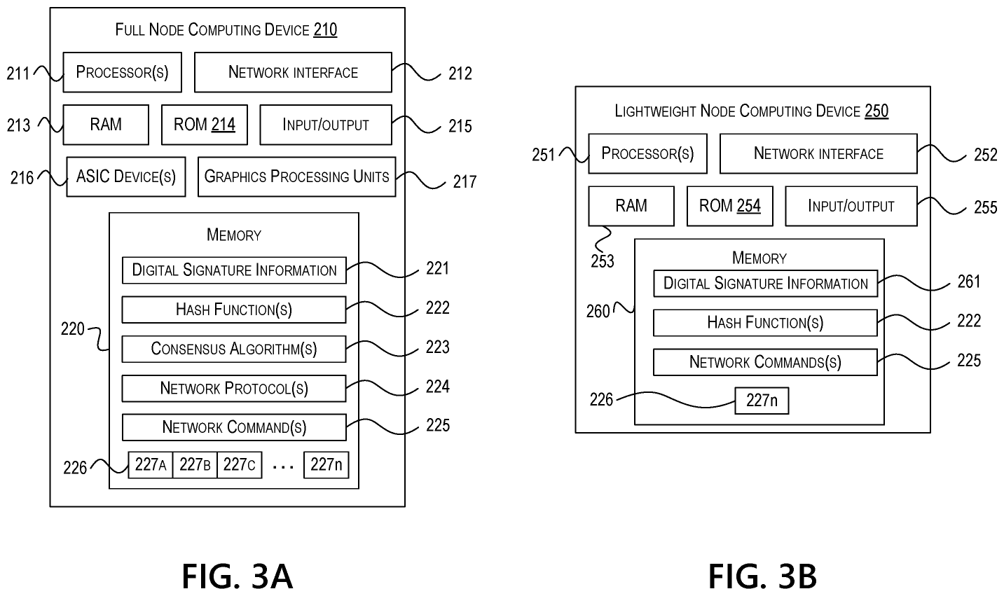

FIG. 2 depicts an illustrative example of a decentralized P2P computer system 200 that may be used in accordance with one or more illustrative aspects described herein. The decentralized P2P computer system 200 may include a plurality of full node computing devices 210A, 210B, 210C, 210D, 210E, and 210F and lightweight node computing devices 250A and 250B, which may be respectively similar to a full node computing device 210 described in regard to FIG. 3A and a lightweight node computing device 250 described in regard to FIG. 3B. While a particular number of full node computing devices and lightweight node computing devices are depicted in FIG. 2, it should be understood that a number of full node computing devices and/or lightweight node computing devices greater or less than that of the depicted full node computing devices and lightweight node computing devices may be included in the decentralized P2P computer system 200. Accordingly, any additional full node computing devices and/or lightweight node computing devices may respectively perform in the manner described below in regard to full the full node computing devices 210A-210F and the lightweight node computing devices 250A and 250B in the decentralized P2P computer system 200.

Each of the full node computing devices 210A-210F may operate in concert to create and maintain a decentralized P2P network 270 of the decentralized P2P computer system 200. In creating the decentralized P2P network 270 of the decentralized P2P computer system 200, processors, ASIC devices, and/or graphics processing units (e.g., GPUs) of each of the full node computing devices 210A-210F may execute network protocols which may cause each of the full node computing devices 210A-210F to form a communicative arrangement with one or more others of the full node computing devices 210A-210F in the decentralized P2P computer system 200 and create the decentralized P2P network 270. Furthermore, the execution of network protocols by the processors, ASIC devices, and/or graphics processing units (e.g., GPUs) of the full node computing devices 210A-210F may cause the full node computing devices 210A-210F to execute network functions related to a blockchain 226 and thereby maintain the decentralized P2P network 270.

The lightweight node computing devices 250A and 250B may request execution of network functions related to the blockchain 226 in the decentralized P2P network 270. In order to request execution of network functions, such as balance sheet transaction and/or smart contract operations, processors of the lightweight node computing devices 250A and 250B may execute network commands to broadcast the network functions to the decentralized P2P network 270 comprising the full node computing devices 210A-210F.

For example, the lightweight node computing device 250A may request execution of a balance sheet transaction related to the blockchain 226 in the decentralized P2P network 270, which may entail a data transfer from a private/public key associated with the lightweight node computing device 250A to a private/public key associated with the lightweight node computing device 250B. In doing so, processors of the lightweight node computing device 250A may execute network commands to broadcast the balance sheet transaction network function request 280 to the decentralized P2P network 270. The balance sheet transaction network function request 280 may include details about the data transfer such as data type and amount, as well as a data transfer amount to the full node computing devices 210A-201F of the decentralized P2P network 270 for executing the balance sheet transaction network function request 280. The balance sheet transaction network function request 280 may further include the public key associated with the lightweight node computing device 250B. Processors of the lightweight node computing device 250A may execute digital signature algorithms to digitally sign the balance sheet transaction network function request 280 with the private key associated with the lightweight node computing device 250A.

At the decentralized P2P network 270, the balance sheet transaction network function request 280 may be broadcasted to each of the full node computing devices 210A-210F through execution of network protocols by the full node computing devices 210A-210F. In order to execute the balance sheet transaction network function request 280 and maintain inter-nodal agreement as to the state of the blockchain 226, processors, ASIC devices, and/or GPUs of the full node computing devices 210A-210F may execute network protocols to receive broadcast of the network function through the decentralized P2P network 270 and from the lightweight node computing device 250A. Processors, ASIC devices, and/or GPUs of the full node computing devices 210A-210F may execute hash functions to generate a digest of the balance sheet transaction network function request 280. The resultant digest of the balance sheet transaction network function request 280, in turn, may be hashed with the block hash of the most immediately preceding block of the blockchain 226. Processors, ASIC devices, and/or GPUs of the full node computing devices 210A-210F may execute consensus algorithms to identify a numerical value (e.g., nonce) corresponding to the particular executed consensus algorithm and related to the digest that combines the digest of the balance sheet transaction network function request 280 and the block hash of the most immediately preceding block of the blockchain 226.

For example, if the consensus algorithm comprises a proof of work (PoW), processors, ASIC devices, and/or GPUs of the full node computing devices 210A-210F may perform a plurality of hashing operations to identify a nonce that, when hashed with the digest that combines the digest of the balance sheet transaction network function request 280 and the block hash of the most immediately preceding block of the blockchain 226, produces a hash of a predetermined alphanumerical format. Such a predetermined alphanumerical format may include a predetermined number of consecutive alphanumerical characters at a predetermined position within the resultant digest that combines the nonce, digest of the balance sheet transaction network function request 280, and block hash of the most immediately preceding block of the blockchain 226.

If the consensus algorithm comprises a proof of stake (PoS), a private key associated with one of the full node computing devices 210A-210F may be pseudo-randomly selected, based on balance sheet holdings associated with the public keys of the full node computing devices 210A-210F, to serve as the nonce. For example, through execution of the PoS consensus algorithm, the full node computing devices 210A-210F are entered into a lottery in which the odds of winning are proportional to a balance sheet amount associated the public key of each of the full node computing devices 210A-210F, wherein a larger balance sheet amount corresponds to a higher probability to win the lottery. The PoS consensus algorithm may cause a full node computing device from the full node computing devices 210A-210F to be selected, and the public key of the selected full node computing device to be used as the nonce.

If the consensus algorithm comprises a delegated proof of stake (DPoS), a group of delegates are chosen from the full node computing devices 210A-210F by each of the full node computing devices 210A-210F, wherein the full node computing devices 210A-210F are allowed to vote on delegates based on balance sheet holdings associated with the respective public keys. The full node computing devices 210A-210F need not vote for themselves to be delegates. Once the group of delegates are chosen, the group of delegates from the full node computing devices 210A-210F select a public key associated with one of the full node computing devices 210A-210F to serve as the nonce. Again, each of the delegates are prohibited from selecting themselves and their respective public key from serving as the nonce.

If the consensus algorithm comprises a practical byzantine fault tolerance algorithm (PBFT), each of the full node computing devices 210A-210F are associated with a particular status and/or ongoing specific information associated with the respective public key of the full node computing devices. Each of the full node computing devices 210A-210F receive a message through the decentralized P2P network 270 based on network protocols. Based on the received message and particular status and/or ongoing specific information, each of the full node computing devices 210A-210F perform computational tasks and transmit a response to the tasks to each of the other full node computing devices 210A-210F. A public key associated with a particular full node computing device from the full node computing devices 210A-210F is selected by each of the full node computing devices 210A-210F based on the response of the particular full node computing device best fulfilling criteria determined based on the network protocols.

The identification of the nonce enables processors, ASIC devices, and/or GPUs of the full node computing device from the full node computing devices 210A-210F to create a new block with a block header (e.g., block hash), which is a digest that combines the digest of the balance sheet transaction network function request 280, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. The new block may also be time-stamped at a time corresponding to the addition to the blockchain 226. Furthermore, as a reward for adding the new block to the blockchain 226, the full node computing device from the full node computing devices 210A-210F may be allowed, per the network protocols, to increase a balance sheet holdings amount associated with itself by a predetermined amount. Each of the full node computing devices 210A-210F may receive an equal portion of the data transfer amount specified by the lightweight node computing device 260A for executing the balance sheet transaction network function request 280. After the new block has been added to blockchain 226, balance sheet transaction network function request 280 may be considered to be executed and the data transfer from the private/public key associated with lightweight node computing device 250A to the private/public key associated with lightweight node computing device 250B may be registered.

As stated above, a plurality of network function requests may be broadcasted across the decentralized network P2P network 270. Processors, ASIC devices, and/or GPUs of full node computing devices 210A-210F may execute network protocols to receive broadcast of each of the network functions, including the balance sheet transaction network function request 280, through the decentralized P2P network 270 and from the requesting entities, including the lightweight node computing device 250A. Processors, ASIC devices, and/or GPUs of the full node computing devices 210A-210F may execute hash functions to generate a hash tree (e.g., Merkle tree) of the requested network functions, which culminates in a single digest (e.g., root digest, root hash, and the like) that comprises the digests of each of the requested network functions, including the balance sheet transaction network function request 280. The root digest of the requested network function, in turn, may be hashed with the block hash of the most immediately preceding block of the blockchain 226. Processors, ASIC devices, and/or GPUs of the full node computing devices 210A-210B may execute consensus algorithms in the manner described above to identify a nonce corresponding to the particular executed consensus algorithm and related to the digest that combines the root digest of the requested network functions and the block hash of the most immediately preceding block of the blockchain 226. The identification of the nonce enables processors, ASIC devices, and/or GPUs of the full node computing device from the full node computing devices 210A-210F to create a new block with a block header (e.g., block hash), which is a digest that combines the root digest of the network function requests, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. The new block may also be time-stamped at a time corresponding to the addition to the blockchain 226. Furthermore, as a reward for adding the new block to the blockchain 226, the full node computing device from the full node computing devices 210A-210F may be allowed, per the network protocols, to increase a balance sheet holdings amount associated with itself by a predetermined amount. Each of the full node computing devices 210A-210F may receive an equal portion of the data transfer amount specified by each of the network function requests. After the new block has been added to the blockchain 226, each of the network functions requests, including the balance sheet transaction network function request 280, may be considered to be executed and the data transfer from the private/public key associated with the lightweight node computing device 250A to the private/public key associated with the lightweight node computing device 250B may be registered.

While the description provided above is made in relation to a balance sheet transaction involving the lightweight node computing device 250A and the lightweight node computing device 250B, it is to be understood that balance sheet transactions are not limited to the lightweight node computing device 250A and the lightweight node computing device 250B, but rather may be made across any of the full node computing devices and/or lightweight node computing devices in the decentralized P2P computer system 200.

For another example, the lightweight node computing device 250B may request a smart contract operation related to the blockchain 226 in the decentralized P2P network 270, which may facilitate a dual data transfer between a private/public key associated with the lightweight node computing device 250B and a private/public key associated with the lightweight node computing device 250A. Processors of the lightweight node computing device 250B may execute network commands to broadcast the smart contract operation network function request 290 to the decentralized P2P network 270. The smart contract operation network function request 290 may include details about the data transfer such as data type and amount, as well as a data transfer amount to the full node computing devices 210A-210F of the decentralized P2P network 270 for executing the smart contract operation network function request 290. The smart contract operation network function request 290 may further include the public key associated with the smart contract. Processors of the lightweight node computing device 250B may execute digital signature algorithms to digitally sign the smart contract operation network function request 290 with the private key associated with the lightweight node computing device 250B.

At the decentralized P2P network 270, the smart contract operation network function request 290 may be broadcasted to each of the full node computing devices 210A-210F through execution of network protocols by the full node computing devices 210A-210F. In order to execute the smart contract operation network function request 290 and maintain inter-nodal agreement as to the state of the blockchain 226, processors, ASIC devices, and/or GPUs of the full node computing devices 210A-210F may execute network protocols to receive broadcast of the network function through the decentralized P2P network 270 and from the lightweight node computing device 250B. Processors, ASIC devices, and/or GPUs of the full node computing devices 210A-210F may execute hash functions to generate a digest of the smart contract operation network function request 290. The resultant digest of the smart contract operation network function request 290, in turn, may be hashed with the block hash of the most immediately preceding block of the blockchain 226. Processors, ASIC devices, and/or GPUs of the full node computing devices 210A-210F may execute consensus algorithms to identify a nonce corresponding to the particular executed consensus algorithm and related to the digest that combines the digest of the smart contract operation network function request 290 and the block hash of the most immediately preceding block of the blockchain 226.

The identification of the nonce enables processors, ASIC devices, and/or GPUs of the full node computing device from the full node computing devices 210A-210F to create a new block with a block header (e.g., block hash), which is a digest that combines the smart contract operation network function request 290, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. The new block may also be time-stamped at a time corresponding to the addition to the blockchain 226. Furthermore, as a reward for adding the new block to the blockchain 226, the full node computing device from the full node computing devices 210A-210F may, per the network protocols, increase a balance sheet holdings amount associated with itself by a predetermined amount. Each of the full node computing devices 210A-210F may receive an equal portion of the data transfer amount specified by the lightweight node computing device 260A for executing the smart contract operation network function request 290. After the new block has been added to the blockchain 226, the smart contract operation network function request 290 may be considered to be executed and the data transfer from the private/public key associated with the lightweight node computing device 250B to the private/public key associated with the smart contract may be registered.

The smart contract may be configured to hold the data transfer from the private/public key associated with the lightweight node computing device 250B until fulfillment of certain predetermined criteria hardcoded into the smart contract is achieved. The smart contract may be configured such that it serves as an intermediate arbiter between entities within the decentralized P2P network 270 and may specify details of a dual data transfer between entities.

The lightweight node computing device 250A may also request a smart contract operation related to the blockchain 226 in the decentralized P2P network 270, which may conclude the dual data transfer between a private/public key associated with the lightweight node computing device 250A and a private/public key associated with the lightweight node computing device 250B. Processors of the lightweight node computing device 250A may execute network commands to broadcast the smart contract operation network function request to the decentralized P2P network 270. The smart contract operation network function request may include details about the data transfer such as data type and amount, as well as a data transfer amount to the full node computing devices 210A-210F of the decentralized P2P network 270 for executing the smart contract operation network function request. The smart contract operation network function request may further include the public key associated with the smart contract. Processors of lightweight node computing device 250A may execute digital signature algorithms to digitally sign the smart contract operation network function request with the private key associated with lightweight node computing device 250A.

At the decentralized P2P network 270, the smart contract operation network function request may be broadcasted to each of the full node computing devices 210A-210F through execution of network protocols by the full node computing devices 210A-210F. In order to execute the smart contract operation network function request and maintain inter-nodal agreement as to the state of the blockchain 226, processors, ASIC devices, and/or GPUs of the full node computing devices 210A-210F may execute network protocols to receive broadcast of the network function through the decentralized P2P network 270 and from the lightweight node computing device 250A. Processors, ASIC devices, and/or GPUs of the full node computing devices 210A-210F may execute hash functions to generate a digest of the smart contract operation network function request. The resultant digest of the smart contract operation network function request, in turn, may be hashed with the block hash of the most immediately preceding block of the blockchain 226. Processors, ASIC devices, and/or GPUs of the full node computing devices 210A-210F may execute consensus algorithms to identify a nonce corresponding to the particular executed consensus algorithm and related to the digest that combines the digest of the smart contract operation network function request and the block hash of the most immediately preceding block of the blockchain 226.

The identification of the nonce enables processors, ASIC devices, and/or GPUs of the full node computing device from the full node computing devices 210A-210F to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices 210A-210F may execute network protocols to add the new block to the blockchain 226 and broadcast the new block to the other full node computing devices in the decentralized P2P network 270. The new block may also be time-stamped at a time corresponding to the addition to the blockchain 226. Furthermore, as a reward for adding the new block to the blockchain 226, the full node computing device from full node computing devices 210A-210F may be allowed, per the network protocols, to increase a balance sheet holdings amount associated with itself by a predetermined amount. Each of full node computing devices 210A-210F may receive an equal portion of the data transfer amount specified by the lightweight node computing device 260A for executing the smart contract operation network function request. After the new block has been added to the blockchain 226, the smart contract operation network function request 290 may be considered to be executed and the data transfer from the private/public key associated with the lightweight node computing device 250A to the private/public key associated with the smart contract may be registered.

When the smart contract receives the data value from each of the lightweight node computing device 250A and the lightweight node computing device 250B, the smart contract may transfer the data value from the lightweight node computing device 250A to the lightweight node computing device 250B and the data value from the lightweight node computing device 250B to the lightweight node computing device 250A.

While the description provided above was made in relation to the lightweight node computing device 250A and the lightweight node computing device 250B, it should be understood that any of the full node computing devices and lightweight node computing devices in the decentralized P2P computer system 200 may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer.

In comparison to the centralized computing system 100 described in regard to FIG. 1, the decentralized P2P computer system 200 may provide technological advantages. For example, by distributing storage of the blockchain 226 across multiple of the full node computing devices 210A-210F, the decentralized P2P computer system 200 may avoid providing a single point of failure for malicious attack. In the event that any of the full node computing devices 210A-210F are compromised by a malicious attacker, the decentralized P2P computer system 200 may continue to operate unabated as data storage of the blockchain 226 and network processes are not controlled by a singular entity such as the server infrastructure 110 of the centralized computing system 100.

Furthermore, by utilizing the blockchain data structure, the decentralized P2P computer system 200 may provide technological improvements to decentralized P2P computer systems in regard to byzantine fault tolerance stemming from an unreliable and/or malicious full node acting in the decentralized P2P network 270 to undermine the work efforts of the other nodes. For example, in coordinating action between the full node computing devices 210A-210F in relation to a similar computational task (e.g., consensus algorithm), a malicious node would need to have computational power greater than the combined computational power of each of the other full node computing devices in the decentralized P2P network 270 to identify the nonce and thereby be able to modify the blockchain 226. As such, the likelihood that a malicious node could subvert the decentralized P2P network 270 and enter falsified data into the blockchain 226 is inversely proportional to the total computational power of the decentralized P2P computer system 200. Therefore, the greater the total computational power of the decentralized P2P computer system 200, the less likely that a malicious node could subvert the decentralized P2P network 270 and undermine the blockchain 226.

FIG. 3A depicts an illustrative example of a full node computing device 210 that may be used in accordance with one or more illustrative aspects described herein. The full node computing device 210 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. The full node computing device 210 may be configured to operate in a decentralized P2P network and may request execution of network functions and/or to execute requested network functions and maintain inter-nodal agreement as to the state of a blockchain of the decentralized P2P network.

The full node computing device 210 may include one or more processors 211, which control overall operation, at least in part, of the full node computing device 210. The full node computing device 210 may further include random access memory (RAM) 213, read only memory (ROM) 214, a network interface 212, input/output interfaces 215 (e.g., keyboard, mouse, display, printer, and the like), and memory 220. The input/output (I/O) 215 may include a variety of interface units and drives for reading, writing, displaying, and/or printing data or files. The full node computing device 210 may further comprise specialized hardware components such as application-specific integrated circuit (ASIC) devices 216 and/or graphics processing units (GPUs) 217. Such specialized hardware components may be used by the full node computing device 210 in performing one or more of the processes involved in the execution of requested network functions and maintenance of inter-nodal agreement as to the state of a blockchain. The full node computing device 210 may further store in the memory 220 operating system software for controlling overall operation of the full node computing device 210, control logic for instructing the full node computing device 210 to perform aspects described herein, and other application software providing secondary, support, and/or other functionality which may or might not be used in conjunction with aspects described herein.

The memory 220 may also store data and/or computer executable instructions used in performance of one or more aspects described herein. For example, the memory 220 may store digital signature information 221 and one or more hash functions 222, consensus algorithms 223, network protocols 224, and network commands 225. The digital signature information 221, the hash functions 222, and/or the network commands 225 may comprise a wallet of the full node computing device 210. The memory 220 may further store the blockchain 226. Each of the digital signature information 221, the hash functions 222, the consensus algorithms 223, the network protocols 224, and the network commands 225 may be used and/or executed by the one or more processors 211, the ASIC devices 216, and/or the GPUs 217 of the full node computing device 210 to create and maintain a decentralized P2P network, request execution of network functions, and/or execute requested network functions and maintain inter-nodal agreement as to the state of the blockchain 226.

For example, in order to create and maintain a decentralized P2P network, the one or more processors 211, the ASIC devices 216, and/or the GPUs 217 of the full node computing device 210 may execute the network commands 225. Execution of the network commands 225 may cause full node computing device 210 to form a communicative arrangement with other full node computing devices and thereby create a decentralized P2P network. Furthermore, the execution of the network commands 225 may cause the full node computing device 210 to maintain the decentralized P2P network through the performance of computational tasks related to the execution of network requests related to a blockchain such as the blockchain 226. As will be described in detail below, the execution of such computational tasks (e.g., the hash functions 222, the consensus algorithms 223, and the like) may cause the full node computing device 210 to maintain inter-nodal agreement as to the state of a blockchain with other full node computing devices comprising the decentralized P2P network.

In order to request execution of network functions, such as balance sheet transactions and/or smart contract operations, the one or more processors 211, the ASIC devices 216, and/or the GPUs 217 of full node computing device 210 may execute the network commands 225 to broadcast the network function to a decentralized P2P network comprising a plurality of full nodes and/or lightweight nodes. The request may be digitally signed by the full node computing device 210 with usage of the private/public key information and through execution of the digital signature algorithms of the digital signature information 221.

In order to execute requested network functions and maintain inter-nodal agreement as to the state of a blockchain, the one or more processors 211, the ASIC devices 216, and/or the GPUs 217 of the full node computing device 210 may execute the network protocols 224 to receive a broadcast of a requested network function through a decentralized P2P network and from a requesting entity such as a full node or lightweight node. The one or more processors 211, the ASIC devices 216, and/or the GPUs 217 of the full node computing device 210 may execute the hash functions 222 to generate a digest of the requested network function. The resultant digest of the requested network function, in turn, may be hashed with the block hash of the most immediately preceding block of the blockchain. As will be described in further detail below, the one or more processors 211, the ASIC devices 216, and/or the GPUs 217 of the full node computing device 210 may execute the consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables the one or more processors 211, the ASIC devices 216, and/or the GPUs 217 of the full node computing device 210 to create a new block with a block header (e.g., block hash), which is a digest that combines the digest of the requested network function, the block hash of the most immediately preceding block, and the identified nonce. The one or more processors 211, the ASIC devices 216, and/or the GPUs 217 of the full node computing device 210 may add the new block to the blockchain based on network protocols 224 and broadcast the new block to the other nodes in the decentralized P2P network.

As stated above, a plurality of network function requests may be broadcasted across the decentralized P2P network. The one or more processors 211, the ASIC devices 216, and/or the GPUs 217 of the full node computing device 210 may execute the network protocols 224 to receive broadcast of each of the network functions through the decentralized P2P network and from the requesting entities. The one or more processors 211, the ASIC devices 216, and/or the GPUs 217 of the full node computing device 210 may execute the hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. The one or more processors 211, the ASIC devices 216, and/or the GPUs 217 of the full node computing device 210 may execute the consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables the one or more processors 211, the ASIC devices 216, and/or the GPUs 217 of the full node computing device 210 to create a new block with a block header (e.g., block hash), which is a digest that combines the root digest of the requested network functions, the block hash of the most immediately preceding block, and the identified nonce. The one or more processors 211, the ASIC devices 216, and/or the GPUs 217 of the full node computing device 210 may add the new block to the blockchain based on network protocols 224 and broadcast the new block to the other nodes in the decentralized P2P network.

Furthermore, the memory 220 of the full node computing device 210 may store the blockchain 226. The blockchain 226 may include blocks 227A, 227B, 227C, . . . 227n, wherein the block 227A represents the first block (e.g., genesis block) of the blockchain 226 and the block 227n represents the most immediate block of the blockchain 226. As such, the blockchain 226, which may be a replica or copy of the blockchain of the decentralized P2P network in which the full node computing device 210 operates, may be a full or complete copy of the blockchain of the decentralized P2P network. Each of the blocks within the blockchain 226 may include information corresponding to the one or more network functions executed by the decentralized P2P network. As such, the blockchain 226 as stored in the memory 220 of the full node computing device 210 may comprise the totality of network functions executed by the decentralized network.

FIG. 3B depicts an illustrative example of a lightweight node computing device 250 that may be used in accordance with one or more illustrative aspects described herein. The lightweight node computing device 250 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. The lightweight node computing device 250 may operate in a decentralized P2P network and may be configured to request execution of network functions through the decentralized P2P network. As such, the lightweight node computing device 250 may be different than the full node computing device 210 in that it is not configured to execute network functions and/or operate to maintain a blockchain of a decentralized P2P network. In other aspects, the lightweight node computing device 250 may have substantially the same physical configuration as the full node computing device 210, but configured with different programs, software, and the like.

The lightweight node computing device 250 may include one or more processors 251, which control overall operation of the lightweight node computing device 250. The lightweight node computing device 250 may further include random access memory (RAM) 253, read only memory (ROM) 254, a network interface 252, input/output interfaces 255 (e.g., keyboard, mouse, display, printer, and the like), and memory 260. The input/output (I/O) 255 may include a variety of interface units and drives for reading, writing, displaying, and/or printing data or files. The lightweight node computing device 250 may store in the memory 260 operating system software for controlling overall operation of the lightweight node computing device 250, control logic for instructing lightweight node computing device 250 to perform aspects described herein, and other application software providing secondary, support, and/or other functionality which may or might not be used in conjunction with aspects described herein.

In comparison to the full node computing device 210, the lightweight node computing device 250 need not include specialized hardware such as the ASIC devices 216 and/or the GPUs 217. Such is the case because the lightweight node computing device 250 might not be configured to execute network functions and/or operate to maintain a blockchain of a decentralized P2P network as is the full node computing device 210. The lightweight node computing device 250 may include such specialized hardware.

The memory 260 of the lightweight node computing device 250 may also store data and/or computer executable instructions used in performance of one or more aspects described herein. For example, the memory 260 may store digital signature information 261 and one or more hash functions 222 and network commands 225. The digital signature information 261, the hash functions 222, and/or the network commands 225 may comprise a wallet of the lightweight node computing device 250. Each of the hash functions 222 and the network commands 225 stored in the memory 260 of the lightweight node computing device 250 may be respectively similar and/or identical to the hash functions 222 network commands 225 stored in the memory 220 of the full node computing device 210.

In regard to the digital signature information, each of the digital signature information 261 stored in the memory 260 of the lightweight node computing device 250 and the digital signature information 221 stored in the memory 220 of the full node computing device 210 may comprise similar and/or identical digital signature algorithms. The private/public key information of the digital signature information 261 stored in the memory 260 of the lightweight node computing device 250 may be different than that of the private/public key information of the digital signature information 221 stored in the memory 220 of the full node computing device 210. Furthermore, the private/public key information of each node, whether full or lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of the digital signature information 261, the hash functions 222, and the network commands 225 may be used and/or executed by the one or more processors 251 of lightweight node computing device 250 to request execution of network functions in a decentralized P2P network. For example, in order to request execution of network functions, such as balance sheet transactions and/or smart contract operations, the processors 251 of the lightweight node computing device 250 may execute the network commands 225 to broadcast the network function to a decentralized P2P network comprising a plurality of full nodes and/or lightweight nodes. The request may be digitally signed by the lightweight node computing device 250 with usage of the private/public key information and through execution of the digital signature algorithms of the digital signature information 261.

Furthermore, the memory 260 of the lightweight node computing device 250 may store the blockchain 226. The blockchain 226 stored in the memory 260 of the lightweight node computing device 250 may include at least block 227n, wherein block 227n represents the most immediate block of the blockchain 226. As such, the blockchain 226, which may be a replica or copy of the blockchain of the decentralized P2P network in which the lightweight node computing device 250 operates, may be a partial or incomplete copy of the blockchain of the decentralized P2P network. The blockchain 226 may include blocks 227A, 227B, 227C, . . . 227n, wherein block 227A represents the first block (e.g., genesis block) of the blockchain 226, and block 227n represents the most immediate block of the blockchain 226. As such, the blockchain 226 may be a full or complete copy of the blockchain of the decentralized P2P network. Each of the blocks within the blockchain 226 may include information corresponding to the one or more network functions executed by the decentralized P2P network.

Blockchains Across Multiple Organizations

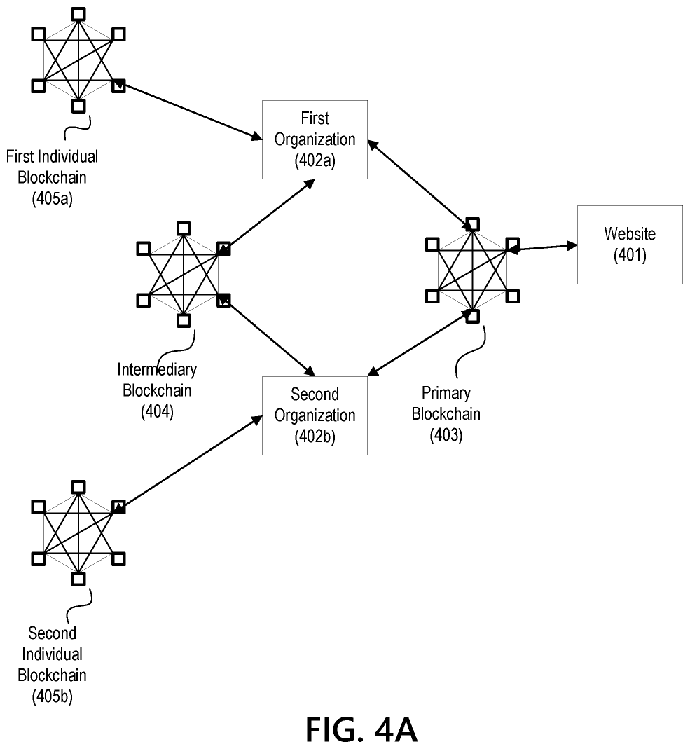

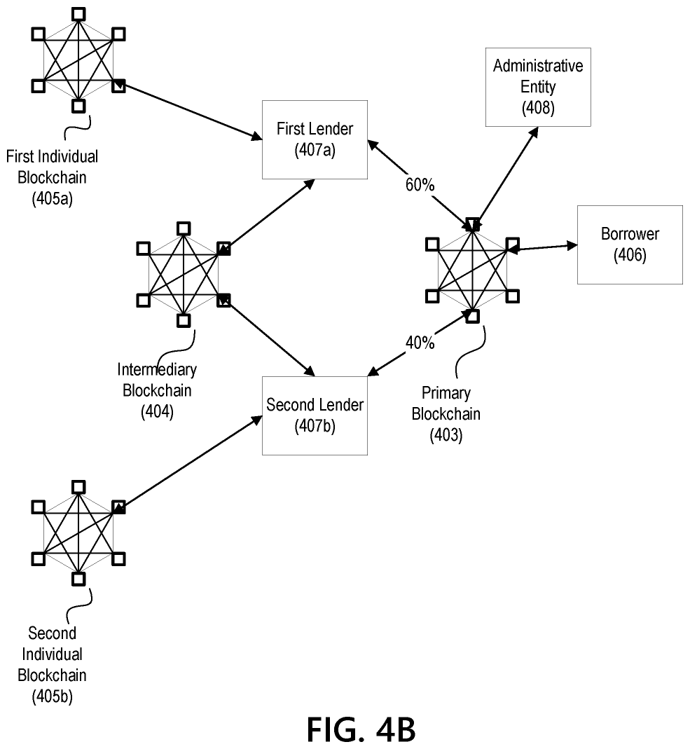

Having discussed blockchain techniques above with respect to FIGS. 1-3, discussion will now turn to features directed to using blockchains with respect to multiple organizations. FIG. 4A depicts multiple organizations and multiple blockchains with respect to a website 401 for which the multiple organizations have agreed to write blog posts. A website 401, first organization 402a, second organization 402b, primary blockchain 403, intermediary blockchain 404, first individual blockchain 405a, and second individual blockchain 405b are shown. A plurality of organizations, such as the first organization 402a and the second organization 402b, may be related to an entity, such as a website 401. For example, the first organization 402a and the second organization 402b may have agreed to write blog posts for the website 401. Such a relationship between the website 401, the first organization 402a, and the second organization 402b may be reflected in one or more blocks created in the primary blockchain 403. The primary blockchain 403 may be configured to store blocks corresponding to relationships between entities (e.g., the website 401, individuals, organizations, or the like) and organizations, such as the first organization 402a and the second organization 402b. The primary blockchain 403 may indicate, for example, that organizations have agreed to write a predetermined number of blog posts for the website 401, but need not particularly identify the organizations. The primary blockchain may store blocks reflecting the relationship in any manner desirable. For example, a block in the primary blockchain 403 may comprise an entire contract, an indication that a contract may exist, an indication that the website 401 has agreed to work with organizations for a particular task, or the like.

Any form of information relating to the first organization 402a and/or the second organization 402b may be stored in the intermediary blockchain 404, and may be related to the one or more blocks in the primary blockchain 403. The relationship between the website 401, the first organization 402a, and the second organization 402b may also be reflected in one or more blocks in the intermediary blockchain 404. The intermediary blockchain 404 may store a block which indicates percentages of a whole associated with each of a plurality of organizations. As an example, blocks in the intermediary blockchain 404 may indicate that the first organization 402a is to write the first half of all blog posts for the website 401, but that the second organization 402b is to write the second half of all of the same blog posts for the website 401. The intermediary blockchain 404 may be a private blockchain. As such, while the primary blockchain 403 may be publicly accessible and indicate the existence of a relationship between an entity (e.g., the website 401) and one or more unidentified organizations, the identity of the one or more organizations may be private as stored in the intermediary blockchain 404.

The first individual blockchain 405a may comprise blocks specific to the first organization 402a, and the second individual blockchain 405b may comprise blocks specific to the second organization 402b. Blocks in the first individual blockchain 405a and/or the second individual blockchain 405b may be related to blocks in the intermediary blockchain 404 and/or the primary blockchain 403. For example, blocks in the first individual blockchain 405a may indicate how many blog posts that the first organization 402a has written, which individuals in the first organization 402a wrote such blog posts, or similar information. The first individual blockchain 405a and the second individual blockchain 405b may be private, and not shared with other organizations or entities.

New blocks may be created in the primary blockchain 403 and/or the intermediary blockchain 404 based on actions by entities, such as the website 401, and/or organizations, such as the first organization 402a and/or the second organization 402b. New blocks may be created in the primary blockchain 403 based on actions involving the entity. For example, activity by entities such as the website 401 (e.g., assignment of new blog posts, payment of monies owed for completed blog posts) may cause creation of a new block into the primary blockchain 403. As a more particularized example, if the website 401 assigns additional blog posts or pays funds for blog posts written by organizations, such actions may be reflected in blocks created in the primary blockchain 403. New blocks may be created in the intermediary blockchain 404 based on changes in relationships between organizations of the plurality of organizations. For example, if the first organization 402a transfers some of its blog post assignments to the second organization 402b, then additional blocks may be added to the intermediary blockchain 404. New blocks may be created in individual blockchains (e.g., the first individual blockchain 405a) based on the activity of a particular organization. For example, if the first organization 402a re-assigns a blog post within the organization from one writer to another, a block may be added to the first individual blockchain 405a.

An example of a use case of FIG. 4A is provided herein. The website 401 may be a national news website which regularly assigns blog posts on local news stories to local freelance news agencies, such as the first organization 402a and the second organization 402b. The assignment, to freelance news agencies, of a particular series of news blog posts relating to a local parade may be reflected in the primary blockchain 403, and the blocks in the primary blockchain 403 corresponding to such an assignment need not specify which agencies will handle which blog posts, or how responsibility for any given blog post may be divided. Such assignments may instead be reflected in the intermediary blockchain 404 that, for example, may specify that the first organization 402a is to write on all local interest stories at the parade, but that the second organization 402b is to write on all political stories at the parade. The particularized assignments for each freelance news agencies, as stored in the intermediary blockchain 404, need not be known by owners of the website 401. Also, the first organization 402a may, using the first individual blockchain 405a, assign portions of assignments to employees of the first organization 402a. For example, the first individual blockchain 405a may contain a block indicating that a first journalist will handle a first local interest story, whereas a second local journalist will handle a second local interest story. Similarly, the second individual blockchain 405b may contain a block indicating that a third journalist will handle a first political story, whereas a fourth local journalist will handle a second political story. If the website 401 were to request a new blog post relating to the parade, a computing device may, using entries in the intermediary blockchain 404, determine which of the organizations may be responsible for the new blog post. After the first organization 402a and the second organization 402b wrote a news story, a block may be created in the primary blockchain 403 to reflect this action. Also, if and when the owner of the website 401 pays money for the blog posts, a block may also be created in the primary blockchain 403. A computing device may be configured to, using blocks in the intermediary blockchain 404, distribute portions of such money to the first organization 402a and the second organization 402b. For example, the computing device may determine, using blocks in the intermediary blockchain 404, how much each organization worked on any given blog post, and distribute portions of the money accordingly.

FIG. 4B depicts use of interconnected blockchains, similar to that of FIG. 4A, for syndicated lending. Syndicated lending may refer to a loan structure where a plurality of lenders are arranged by a central entity (e.g., a bank) to provide a loan to one or more borrowers. As shown in FIG. 4B, an entity (a borrower 406) may be connected to organizations (a first lender 407a and a second lender 407b), e.g., by an administrative entity 408. For example, the borrower 406 may be a clothing store which went to the administrative entity 408 (e.g., a bank) for a loan (e.g., for one hundred dollars), and the administrative entity 408 may have acquired sixty percent of the funds provided to the borrower 406 (e.g., sixty dollars) from the first lender 407a, and forty percent of the funds provided to the borrower 406 (e.g., forty dollars) from the second lender 407b.

The primary blockchain 403 depicted in FIG. 4B may comprise blocks corresponding to this loan (e.g., the loan amount, loan terms, identity of the borrower 406, identity of the administrative entity 408), but need not comprise information on which lender provided any given portion of the loan. Information regarding the lenders, including the particular percentages of the loan provided by each respective lender, may be stored in the intermediary blockchain 404. For example, the intermediary blockchain may comprise blocks indicating that the first lender 407a provided sixty percent of the loan to the borrower 406, whereas the second lender 407b provided forty percent of the loan to the borrower 406. Blocks may be created in the intermediary blockchain 404 if, for example, the first lender 407a sells a portion of the loan, e.g., to the second lender 407b. In this manner, the borrower 406 need not know the particular identities of the lenders in the transaction, and the first lender 407a and second lender 407b may freely transfer rights in the loans provided to the borrower 406 without direct involvement by the borrower 406. When the borrower makes a payment on the loan, a block may be created in the primary blockchain 403, and, using blocks in the intermediary blockchain 404, the payment may be apportioned to different lenders based on their relative ownership of the loan. Such apportionment may be caused by a computing device, e.g., managed by the administrative entity 408.

The first individual blockchain 405a may comprise blocks relating to the ownership interest, of the first lender 407a, in the loan provided to the borrower 406. Similarly, the second individual blockchain 405b may comprise blocks relating to the ownership interest, of the second lender 407b, in the loan provided to the borrower 406. For example, the first individual blockchain 405a may comprise blocks for the payment made by the first lender 407a, via the administrative entity 408, to the borrower 406. As another example, the first individual blockchain 405a may comprise blocks indicating loan payments received from the borrower 406, via the administrative entity 408, to the first lender 407a. As such, blocks in the first individual blockchain 405a and/or the second individual blockchain 405b may correspond to accounts maintained by the first lender 407a and/or the second lender 407b.

Genesis blocks may be created in the blockchains depicted in FIG. 4B based on the creation of a loan. When the loan to the borrower 406 is initially created, genesis blocks corresponding to the payment of funds, from the first lender 407a and the second lender 407b to the borrower 406, may be created in the first individual blockchain 405a, the second individual blockchain 405b, the intermediary blockchain 404, and the primary blockchain 403. For example, a genesis block in the primary blockchain 403 may indicate a one thousand dollar loan, a genesis block in the intermediary blockchain 404 may indicate that the first lender 407a provided six hundred dollars (that is, sixty percent of the loan) and that the second lender 407b provided four hundred dollars (that is, forty percent of the loan), a genesis block in the first individual blockchain 405a may show a payment of six hundred dollars, and a genesis block in the second individual blockchain may show a payment of four hundred dollars.

Additional blocks may be created in the blockchains depicted in FIG. 4B based on activity with respect to a loan. For example, if a borrower pays an amount due based on a loan, the payment may be reflected in a block in the primary blockchain 403 (e.g., reducing principal or interest owed), in a block in the intermediary blockchain 404 (e.g., showing a total amount received and how much is owed each lender), and/or in a block in the first individual blockchain 405a and/or in a block in the second individual blockchain 405b (e.g., showing receipt of such funds).

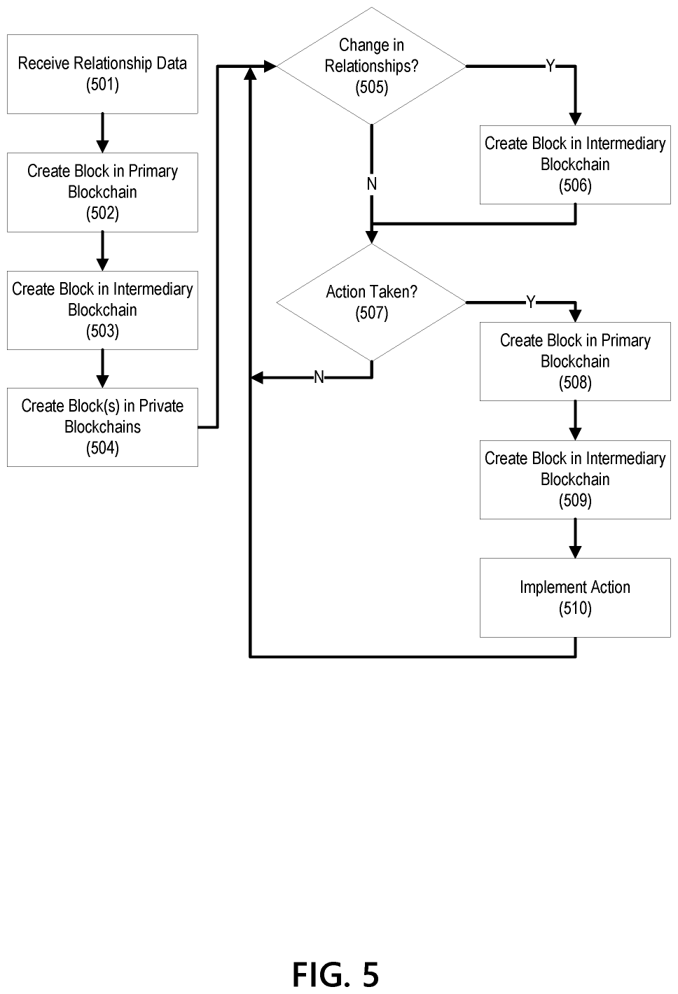

FIG. 5 is a flow chart which may be performed by a computing device and with respect to multiple blockchains and multiple organizations. In step 501, relationship data may be received. The relationship data may reflect a contract or similar obligation, such as an obligation to perform an action (e.g., write blog posts, pay back a loan with interest, or the like). The relationship data may comprise one or more indications of a relationship, such as the name of a borrower and an amount borrowed, but need not specify, e.g., the organization(s) to which such an amount is owed. For example, the relationship data may indicate that a plurality of unnamed organizations agreed to write blog posts for a website. The relationship data may be, e.g., received from another computing device. The relationship data may relate to a relationship between an entity (e.g., a website, a borrower, an organization, or the like) and a plurality of organizations (e.g., lenders, news organizations, or the like). The relationship data may additionally and/or alternatively relate to relationships between the plurality of organizations. For example, the relationship data may indicate that one lender provided a particular percentage of a loan.

In step 502, based on the relationship data, a block may be created in the primary blockchain 403. The block may comprise an indication of the existence of an agreement, such as a contract, the existence of a loan, or the like. The block may comprise the relationship data corresponding to the entity, but need not comprise relationship data corresponding to the plurality of organizations. For example, the block may indicate that a borrower has taken out a loan from one or more unnamed lenders. The block need not indicate the identity of the plurality of organizations, and the block need not indicate relationships between the plurality of organizations.

In step 503, based on the relationship data, a second block may be created in the intermediary blockchain 404. The second block may correspond to the identity of and/or relationships between the plurality of organizations. For example, the second block may indicate how much of a particular blog post any given organization is responsible for writing. As another example, the second block may indicate how much of a loan taken out by a borrower is owned by a particular organization.

In step 504, based on the relationship data, one or more blocks may be created in private blockchains managed by organizations of the plurality of organizations. One or more organizations of the plurality of organizations may maintain a private blockchain which, e.g., may be a private ledger of activities with respect to one or more entities. For example, each organization may maintain a blockchain which tracks loan payments. The one or more blocks created in step 504 may indicate, for example, an amount of a loan provided to a borrower, and/or one or more payments (or portions of payments) received from the borrower. Different organizations may have different requirements for adding a block to their respective private blockchain. For example, one organization may only track monies paid and/or received associated with blog posts written by the organization, whereas another organization may only track blog posts assigned and completed without regard to monies paid and/or received associated with such blog posts.

The creation of the blocks in step 502, step 503, and step 504 need not be performed by the same computing device. For example, because the intermediary blockchain 404 may be private, creation of a block in the intermediary blockchain 440 may be performed by a different computing device than the creation of the block in the primary blockchain 403.

In step 505, it is determined whether a change in relationships involving the entity and/or one or more of the plurality of organizations is detected. A change in a relationship may be, for example, transferring of a blog post responsibility to a different organization, sale of a percentage of a loan to an organization, or the like. For example, a news organization may delegate responsibility for a particular portion of a blog post to a different news organization. As another example, a lender may sell one or more rights associated with a loan to a different lender. If the answer to step 505 is true, the flow chart proceeds to step 506. Otherwise, the flow chart continues to step 507.

In step 506, based on the change in relationships, a block may be created in the intermediary blockchain 404. The block may indicate the change in relationships. For example, if an organization's responsibility to write a blog post is transferred to a different organization, a block indicating such a transfer may be created in the intermediary blockchain 404.

In step 507, it is determined whether an action has been taken with respect to an entity. An action may be any activity which may affect, directly or indirectly, the entity and/or one or more of the plurality of organizations. Actions may correspond to, for example, the relationship specified in one or more blocks in the primary blockchain 403. For example, the block in the primary blockchain 403 may require that the plurality of organizations write a blog post, the action may be writing the blog post. As other examples, the borrower 406 may make a payment on a loan, and/or additional funds may be issued to the borrower 406 by one of the plurality of organizations. If the answer to step 507 is true, the flow chart proceeds to step 508. Otherwise, the flow chart returns to step 505.

In step 508, a block based on the action may be created in the primary blockchain 403. For example, the primary blockchain 403 may be updated to indicate that a blog post has been written, and/or that payment on a loan has been made. The block may provide details as to the event, such as a copy of the blog post, a transaction identifier for a payment, or the like.

In step 509, a block based on the action may be created in the intermediary blockchain 404. The block may indicate the existence of the action such that, if relationships between one or more organizations are contingent on the action, the relationships may be appropriately modified. For example, if an organization is tasked with only writing three blog posts, blocks may be added to the intermediary blockchain 404 indicating that a blog post has been written such that the amount of blog posts written by the organization may be counted.

In step 510, the action may be implemented. Implementation of the action may depend on the nature of the action and the relationships amongst the entity and/or the plurality of organizations. For example, if the action is to assign a blog post to the plurality of organizations, responsibility for the blog post may be determined based on the relationships between the plurality of organizations. If the action is the completion of a blog post by one or more entities, the blog post may be added to the website 401. If the action is a payment, by a borrower and associated with a loan, the payment may be divided into portions based on the relationships between the plurality of organizations and, if desired, transferred automatically to the plurality of organizations (e.g., by a computing device managed by the administrative entity 408).

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a first computing device, an indication of a relationship between an entity and a plurality of organizations;
creating, by the first computing device and based on the relationship, a first block in a first blockchain associated with the entity;
creating, by the first computing device and based on the relationship, a second block in a second blockchain associated with the plurality of organizations, wherein the second block indicates relationships between organizations in the plurality of organizations and with respect to the entity;
determining, by the first computing device, a change in a second relationship between a first organization of the plurality of organizations and a second organization of the plurality of organizations; and
creating, based on the change in the relationship, a third block in the second blockchain.

2. The method of claim 1, further comprising:
causing, for a first organization of the plurality of organizations, creation of a fourth block in a private blockchain associated with the first organization, where the fourth block indicates a third relationship between the first organization and the entity.

3. The method of claim 1, wherein the relationship between the entity and the plurality of organizations corresponds to an obligation, of the entity, to perform an action.

4. The method of claim 3, further comprising:
determining that the entity has performed the action;
creating, based on the action, a fourth block in the first blockchain; and
creating, based on the action and the relationships between the organizations in the plurality of organizations and with respect to the entity, a fifth block in the second blockchain.

5. The method of claim 1, wherein the relationship between the entity and the plurality of organizations corresponds to an obligation, of the plurality of organizations, to perform an action.

6. The method of claim 5, further comprising:
determining that a least one organization of the plurality of organizations has performed the action;
creating, based on the action, a fourth block in the first blockchain; and
creating, based on the action and the relationships between the organizations in the plurality of organizations and with respect to the entity, a fifth block in the second blockchain.

7. The method of claim 1, wherein each of the plurality of organizations manage one or more nodes associated with the second blockchain.

8. The method of claim 1, wherein the first block does not identify the plurality of organizations.

9. A system comprising:
a first computing device associated with a first blockchain; and
a second computing device associated with a second blockchain;
wherein the first computing device is configured to:
determine a loan associated with a borrower and a plurality of lenders;
create, based on the loan, a first block in the first blockchain;
determine that the borrower has made a payment associated with the loan; and
cause transmitting of, based on the payment and further based on a second block in the second blockchain, a portion of the payment to one of the plurality of lenders; and
wherein the second computing device is configured to:
create, based on the loan, the second block in the second blockchain, wherein the second block indicates percentages of the loan associated with different lenders of the plurality of lenders.

10. The system of claim 9, wherein the first computing device is further configured to:
create, based on the payment, a third block in the first blockchain.

11. The system of claim 9, wherein the second computing device is further configured to:
create, based on the portion of the payment, a third block in the second blockchain.

12. The system of claim 9, further comprising:
a third computing device associated with a third blockchain and the one of the plurality of lenders, wherein the third blockchain comprises a third block associated with the portion of the payment.

13. The system of claim 9, wherein the second computing device is further configured to:
determine a change in the percentages of the loan associated with the different lenders of the plurality of lenders; and
create, based on the change, a third block in the second blockchain.

14. The system of claim 9, wherein the first block does not identify the plurality of lenders.

15. A method comprising:
determining, by a first computing device, a loan associated with a borrower and a plurality of lenders;
creating, based on the loan, a first block in a first blockchain associated with the borrower;
creating, based on the loan, a second block in a second blockchain associated with the plurality of lenders, wherein the second block indicates percentages of the loan associated with different lenders of the plurality of lenders;
determining, by the first computing device, that the borrower has made a payment associated with the loan; and
causing transmitting, based on the payment and further based on the second block, a portion of the payment to one of the plurality of lenders.

16. The method of claim 15, further comprising:
creating, based on the payment, a third block in the first blockchain.

17. The method of claim 15, further comprising:
creating, based on transmitting the portion of the payment to the one of the plurality of lenders, a third block in the second blockchain.

18. The method of claim 15, further comprising:
creating, based on transmitting the portion of the payment to the one of the plurality of lenders, a fourth block in a third blockchain, wherein the third blockchain is managed by the one of the plurality of lenders.

19. The method of claim 15, further comprising:
determining, by the first computing device, a change in the percentages of the loan associated with the different lenders of the plurality of lenders; and
creating, based on the change, a third block in the second blockchain.

20. The method of claim 15, wherein the first block does not identify the plurality of lenders.
